(19) United States
(12) Patent Application Publication
(10) Pub. No.: US 2024/0343361 A1
(43) Pub. Date: Oct. 17, 2024

(54) SURFACING DEVICE, INFORMATION MANAGEMENT DEVICE, AND DETACHABLE MOVING BODY

(71) Applicants: AMUZA JAPAN CO., LTD., Tokyo (JP); PATENT INVESTMENT CO., LTD., Tokyo (JP)

(72) Inventors: Kiyotaka Miyagawa, Tokyo (JP); Daigo Kusano, Tokyo (JP)

(21) Appl. No.: 18/681,563

(22) PCT Filed: Aug. 6, 2021
(86) PCT No.: PCT/JP2021/029381

§ 371 Date: Feb. 6, 2024

(51) Int. Cl. B63C 7/26; B63G 8/41; B64U 70/50; B64U 101/20

(52) U.S. Cl. CPC B63C 7/26; B63G 8/41; B64U 70/50; B64U 2101/20

(57) ABSTRACT

The present invention addresses the problem of achieving communication with the outside at a position different from a position at which a surfacing device has surfaced. A surfacing device 100 is released from a submerging body 200 sunk underwater UW to surface overwater OW and communicates with an external communicator 300. The surfacing device 100 comprises: a surfacing unit which surfaces, from underwater UW to overwater OW, the surfacing device 100 released from the submerging body 200; a communication unit which can transmit target information to the external communicator 300 after the surfacing device 100 has surfaced from underwater UW to overwater OW; and a moving unit which moves a target portion, which is at least a part of the surfacing device 100, after the surfacing device 100 has surfaced from underwater UW to overwater OW.

### TECHNICAL FIELD

This disclosure relates to a surfacing device, an information management device, and a separable mobile body.

### BACKGROUND TECHNOLOGY

There have been known technologies for enabling communication with the outside world in the event of an accident or distress in a submersible body submerged in under-water. For example, Patent Literature 1 discloses a technology in which a surfacing device is released from a mother ship that has become immobile at the bottom of water, and the surfacing device uses buoyancy to rise to the surface of water and transmit a distress signal from a position where the surfacing device has surfaced.

### PRIOR ART DOCUMENT

### Patent Literature

Patent Document 1: Japanese Patent Laid-Open No. 2002-314439

### SUMMARY OF THE INVENTION

### Problems to be Solved by the Invention

In the above-mentioned technology, the surfacing device transmits a distress signal from a position at which the surfacing device has surfaced. However, the position from which the surfacing device has surfaced is not necessarily a suitable position for transmitting a distress signal. In other words, it may be easier for an external communication device to receive a distress signal if the distress signal is sent from a different position than the one from which the surfacing device has surfaced.

The purpose of the surfacing device, the information management device, and the separable mobile body of the present disclosure is to enable the surfacing device to communicate with the outside world at a position different from a position from which the surfacing device has surfaced.

### Means of Solving Problems

A surfacing device (100) pertaining to an aspect of the present disclosure is a surfacing device (100) that is released from a submersible body (200) submerged in under-water (UW) to above-water (OW) and communicate with an external communication device (300), the surfacing device comprising:
a surfacing unit (20) that causes the surfacing device (100) released from the submersible body (200) to float from under-water (UW) to above-water (OW);
a communication unit (10) capable of transmitting target information to an external communication device (300) after the surfacing device (100) has surfaced from under-water (UW) to above-water (OW); and
movement units (13) for moving a target part which is at least a part of the surfacing device (100) after the surfacing device (100) has surfaced from under-water (UW) to above-water (OW).

According to this surfacing device (100), after the surfacing device (100) is released from the submersible body (200) and surfaces from under-water (UW) to above-water (OW), the target part can be moved from the surfaced position. Therefore, the surfacing device (100) can communicate with the outside world at a different position from which it has surfaced by using the moved target part.

In the surfacing device (100) according to an aspect of the present disclosure, the movement units (13) may move the target part by making it to fly, and the communication unit (10) may transmit target information to the external communication device (300) after the target part starts flying by the movement unit (13). In this way, the target part flies higher than water surface (WS), thereby increasing the sight distance from the target part. Accordingly, communication with the external communication device (300) can become easier.

In the surfacing device (100) according to an aspect of the present disclosure, the communication unit (10) may transmit target information to the external communication device (300), while in a state where the target part is flying at an altitude of 15 meters or higher by the movement units (13). Accordingly, the action and effect produced by the above-mentioned surfacing device (100) can be more concretely realized.

In the surfacing device (100) according to an aspect of the present disclosure, the movement units (13) may cause the target part to fly by generating an upward propulsive force that propels the target part upward. In other words, the target part may be propelled upward by the upward propulsive force while its position is not necessary to be controlled laterally. Accordingly, the movement units (13) may use more of the energy (among the energy available to move the target part) available to move the target part for upward propulsion. Thus, the target part can be raised to a higher altitude, thereby increasing a sight distance from the target part.

In the surfacing device (100) according to an aspect of the present disclosure, the movement units (13) may cause the flying target part to descend directly downwards. Accordingly, the position coordinates at which the target part was flying and the position coordinates at which the target part was descended can be roughly aligned with each other. Therefore, by detecting the position coordinates at which the target part has descended, it becomes easier to estimate the position coordinates at which the target part was flying.

In the surfacing device (100) according to an aspect of the present disclosure, the movement units (13) may cause the flying target part to descend toward a position different from direct-below. Accordingly, the target part can change its position coordinates as it descends, thus enabling the descent to have a wider area. This may also be achieved, for example, by suppressing the lateral control of the movement units (13), in which case the energy consumption by the movement units (13) may be reduced.

In the surfacing device (100) according to an aspect of the present disclosure, the movement units (13) can make the flying target part to stay in the same position after the target information is transmitted to the external communication device (300) by the communication unit (10). Accordingly, the target part can be made to stay at a position where the target information can be more reliably transmitted to the external communication device (300). Therefore, if the target information needs to be transmitted again to the external communication device (300), the information can be transmitted promptly. In addition, since the target part remains in the same position, the surfacing device (100) can be easily discovered by others.

In the surfacing device (100) according to an aspect of the present disclosure, the movement units (13) may stop operation after the target information is transmitted to the external communication device (300) by the communication unit (10). Accordingly, energy consumption by the movement units (13) can be suppressed.

A surfacing device (100) according to an aspect of the present disclosure is equipped with a separable mobile body (1) that is a part of the surfacing device (100), wherein the separated mobile body (1) is equipped with a communication unit (10) and movement units (13), and after the surfacing device (100) is raised from under-water (UW) to above-water (OW), it may be separated from the remaining portions of the surfacing device (100) and moved by the movement units (13). According to this method, energy consumption by the movement units (13) can be reduced because only the separated mobile body (1) is moved rather than all of the surfacing device (100). In addition, since the separated mobile body (1) is provided with a communication unit (10), it is possible to communicate with the outside world from the separated mobile body (1) that has been moved.

In the surfacing device (100) according to an aspect of the present disclosure, the movement units (13) may move the separated mobile body (1) by making it to fly. Accordingly, the separated mobile body (1) may fly higher than water surface (WS), thereby increasing the sight distance from the separated mobile body (1). Therefore, communication with the external communication device (300) can be made easier.

The surfacing device (100) according to an aspect of the present disclosure is equipped with a container (2) having an opening/closing portion (22), which, when the opening/closing portion (22) is closed, can contain the separated mobile body (1) in a sealed state and, when the opening/closing portion (22) is opened, can release the sealed state and move the separated mobile body (1) from the inside to the outside. Here, the mobile body (1) may be separated from the container (2) and moved by the movement units (13), when in a state where the opening/closing portion (22) is in the closed container (2), the surfacing device (100) has floated from under-water (UW) to above-water (OW) and the opening/closing portion (22) has opened. In this way, the separated mobile body (1) can be suppressed from coming into contact with water by keeping the separated mobile body (1) sealed inside the container (2) until the surfacing device (100) has surfaced from under-water (UW) to above-water (OW). After the surfacing device (100) has surfaced from under-water (UW) to above-water (OW), the mobile body (1) can be separated from the container (2) and can thus be moved.

The surfacing device (100) according to an aspect of the present disclosure is provided with a detection unit (21) which detects that the surfacing device (100) has surfaced from under-water (UW) to above-water (OW), and when the detection unit (21) detects that the surfacing device (100) has surfaced from under-water (UW) to above-water (OW), the container (2) may be such that its opening/closing portion (22) can be opened. Accordingly, the action and effect of the surfacing device (100) can be suitably achieved. Namely, it becomes possible to suppress the contact of the mobile body (1) with water by keeping the mobile body (1) sealed inside the container (2) until the surfacing device (100) has surfaced from under-water (UW) to above-water (OW). In addition, the action and effect of the surfacing device (100) can be suitably achieved. Namely, it is possible to separate the mobile body (1) from the container (2) and to move the separated mobile body (1) after the surfacing device (100) has surfaced from under-water (UW) to above-water (OW).

In the surfacing device (100) according to an aspect of the present disclosure, the container (2) may be filled with oil (F) when the opening/closing portion (22) is in its closed state. Accordingly, the oil (F) can function as so-called equalizing oil to suppress water pressure applied to the equipment inside the container (2) of the separated mobile body (1). The oil (F) also makes it possible to protect the equipment inside the surfacing device (100) from water in the event that the surfacing device (100) is subjected to water.

In the surfacing device (100) according to an aspect of the present disclosure, the container (2) may be configured so that the average density is 2.0 g/cm3 or less. Accordingly, since the weight of the container (2) can be reduced, the weight of the container (2) can be prevented from interfering with the levitation of the surfacing device (100).

The surfacing device (100) according to an aspect of the present disclosure is provided with a fixing unit capable of fixing the separable mobile body (1) and the container (2) to each other, while in a state where the separable mobile body (1) is housed inside the container (2). With the separable mobile body (1) housed inside the container (2) where the opening/closing portion (22) is in the closed state, and after the surfacing device (100) has emerged from under-water (UW) to above-water (OW), the opening/closing portion (22) can be made open, and the fixing with the container (2) based on fixing unit can be released, so that the separable mobile body (1) may be separated from the container (2) and moved by the movement units (13). Accordingly, it is possible to suppress the tilting or tipping of the separated mobile body (1) inside the container (2) due to, for example, ocean currents or water waves or the like (before the separable mobile body (1) is separated from the container (2)).

In the surfacing device (100) according to an aspect of the present disclosure, the container (2) may be provided with a curved surface portion (C) whose outer surface is composed of a curved surface and a non-curved surface portion (P) whose outer surface is composed of a flat surface. Accordingly, it is easier to improve the pressure resistance of the container (2) in the curved surface portion (C), and it is easier to form an opening/closing mechanism of the opening/closing portion (22) in the non-curved surface portion (P).

In the surfacing device (100) according to an aspect of the present disclosure, the separated mobile body (1) may float in water. Accordingly, it is possible to prevent the separated mobile body (1) from being submerged in water when it descends to water surface (WS).

In the surfacing device (100) according to an aspect of the present disclosure, the submersible body (200) may be a boardable submersible body on which a crew member can board. In this way, the action and effect obtainable by the surfacing device (100) described above can be more specifically realized. In particular, the surfacing device (100) can be used to transmit a distress signal to request rescue of the crew.

In the surfacing device (100) according to an aspect of the present disclosure, the movement units (13) may move the target part in a specific direction. Accordingly, by moving the target part in a direction toward a position where the target information is more likely to be received, communication with the external communication device (300) can be made easier.

The surfacing device (100) according to an aspect of the present disclosure is provided with a judgment unit (11) that judges whether or not the external communication device (300) has received the target information transmitted to the external communication device (300) by the communication unit (10). If the judgment unit (11) determines that the target information has been received by the external communication device (300), the movement units (13) may not move the target part. Accordingly, when the target information is received by the external communication device (300), since the mobile body (1) is not moved, it is possible to inhibit an energy consumption on the movement units (13).

In the surfacing device (100) according to an aspect of the present disclosure, the target information may include position information indicating the position of at least one of the submersible body (200) and the surfacing device (100). In this way, information regarding the current position of the submersible body (200) can be transmitted to the external communication device (300). In particular, when the rescue signal of the submersible body (200) is transmitted as the target information, it will be easier for the rescue to be executed more quickly.

In the surfacing device (100) according to an aspect of the present disclosure, the target information may include status information indicating the status of the submersible body (200). Accordingly, information on the current status of the submersible body (200) can be transmitted to the external communication device (300). In addition, when the rescue team or the like obtains the information on the current status of the submersible body (200) via the external communication device (300), the rescue team or the like can be made aware of the information on the current status of the submersible body (200).

In the surfacing device (100) according to an aspect of the present disclosure, the target information may have a data volume of 1 B or more and 50 B or less. Accordingly, since the data volume of the target information can be reduced, the target information can be transmitted farther.

In the surfacing device (100) according to an aspect of the present disclosure, the communication unit (10) may communicate with an external communication device (300) by radio waves with a frequency of 1000 MHz or lower. Accordingly, the wavelength of the radio wave to be used for communication can be made longer, so that the target information can be transmitted still farther.

The surfacing device (100) according to an aspect of the present disclosure has a movement parameter setting unit (12) that sets movement parameters indicating at least one of distance, altitude, and time over which the target part should move. The movement unit (13) may move the target part according to the movement parameters set by the movement parameter setting unit (12). In this way, by moving the target part to a position where the target information can be easily received, communication with the external communication device (300) can be made easier.

In the surfacing device (100) according to an aspect of the present disclosure, the movement units (13) can move the target part until the energy available to the movement units (13) for moving the target part (among the energy available to the surfacing device (100)) is exhausted. The communication unit (10) may transmit the target information to the external communication device (300) until the energy available to the communication unit (10) for transmitting the target information to the external communication (300) is exhausted. Accordingly, since the movement units (13) and the communication unit (10) will have more energy available, this will facilitate successful communication with the external communication device (300). Also, since the movement units (13) and the communication unit (10) can use more energy, the amount of data that can be communicated with the external communication device (300) can be increased.

In the surfacing device (100) according to an aspect of the present disclosure, the movement units (13) may be able to select a test moving mode in which the target part is test moved to confirm the operation of the movement units (13). Accordingly, it is possible to check in advance whether the movement units (13) can operate properly or not.

In the surfacing device (100) according to an aspect of the present disclosure, the communication unit (10) may be able to select a test communication mode in which test information is transmitted to an external communication device (300) to confirm the operation of the communication unit (10). Accordingly, it is possible to confirm in advance whether or not the communication unit (10) can operate properly.

The information management device (400) in accordance with an aspect of the present disclosure includes: an identification information acquiring unit (30) for acquiring identification information concerning any of the above-mentioned surfacing devices (100); a target information acquiring unit (31) for acquiring target information transmitted to an external communication device (300) by the communication unit (10) provided in the surfacing device (100); an information management unit (33) that manages the identification information acquired by the identification information acquisition unit (30) and the target information acquired by the target information acquisition unit (31) by linking them to each other.

According to the information management device (400), it is possible to manage the target information transmitted to the external communication device (300) for each surfacing device (100) that can communicate with the outside world at a different position from a position at which the surfacing device has surfaced.

In the information management device (400) according to an aspect of the present disclosure, the target information may include status information indicating the status of the submersible body (200). Accordingly, information on the status of the submersible body (200) can be managed.

The information management device (400) according to an aspect of the present disclosure may be provided with a correspondence information generating unit (35) that generates correspondence information concerning correspondence to the submersible body (200) after the target information is obtained by the target information obtaining unit (31). Accordingly, information on rescue response after receiving target information such as distress signals can be managed, enabling administrators or the like to grasp the status of response to the submersible body (200).

The information management device (400) according to an aspect of the present disclosure is provided with a contact information acquiring unit (32) for acquiring contact information of a contact person concerning the submersible body (200), while the information management unit (33) manages the contact information acquired by the contact information acquiring unit (32) by linking it with identification information, and when new target information has been acquired by the target information acquiring unit (31), an information contacting unit (34) can be further provided that contacts the contact person based on the contact information tied to the identification information which is in turn tied to the target information. In this way, it is possible to manage the contact information of the contact person regarding the submersible body (200) for each surfacing device (100) that can communicate with the outside world at a position different from the position at which the surfacing device has surfaced. Then, when new target information is acquired, it is possible to contact the contact person of the submersible body (200) pertaining to the surfacing device (100) that has transmitted the target information. Thus, for example, when a distress signal is transmitted from the surfacing device (100) of one of the submersible bodies (200), it is possible to quickly contact the persons concerned of that submersible body (200).

The separable mobile body (1) in accordance with an aspect of the present disclosure is a separable body (1) which is part of a surfacing device (100) that is released from a submersible body (200) submerged in under-water (UW) and has surfaced to above-water (OW) by a surfacing unit (20) and communicates with an external communication device (300). The separated mobile body (1) includes: a communication unit (10) capable of transmitting target information to the external communication device (300) after the surfacing device (100) has surfaced from under-water (UW) to above-water (OW); and movement units (13) which can move the separated mobile body (1) which is separated from the remaining portions of the surfacing device (100), all after the surfacing device (100) has surfaced from under-water (UW) to above-water (OW).

According to the separable mobile body (1), after the surfacing device (100) equipped with the separable mobile body (1) is released from the submersible body (200) and has surfaced from under-water (UW) to above-water (OW), the separated mobile body (1) can be moved from the surfacing position. Therefore, the separated mobile body (1) can communicate with the outside world at a position different from a position at which the surfacing device (100) has surfaced.

The reference numerals in parentheses above are the codes of the components in the embodiments described below (serving as examples of the present disclosure), and the present disclosure is not limited to these embodiments.

### Effects of the Invention

The surfacing device, information management device, and separated mobile body of the present disclosure can communicate with the outside world at a position different from a position at which the surfacing device has surfaced.

### BRIEF DESCRIPTION OF THE DRAWINGS

FIG. 1 is a block diagram of a surfacing device and an information management device according to the first embodiment.

FIG. 2 shows a communication between the surfacing device and the external communication device.

FIG. 3 shows a surfacing device mounted on a submersible body submerged in under-water.

FIG. 4 shows a surfacing device released from the submersible body.

FIG. 5 shows a surfacing device floating on the surface of water.

FIG. 6 shows a surfacing device with the opening/closing portion of the container in its open state.

FIG. 7 shows a container with its opening/closing portion in an open state, also shows a separated mobile body that has started its flight from the container.

FIG. 8 shows a separated mobile body being propelled upward from the container.

FIG. 9 shows a separated mobile body descending from a state of flight to a state of going straight down.

FIG. 10 shows a separated mobile body descending from a flying state to a position different from direct-below.

FIG. 11 shows a surfacing device according to a second embodiment.

### EMBODIMENTS FOR CARRYING OUT THE INVENTION

The following are descriptions of exemplary embodiments with reference to the drawings. The same symbols are attached to the same or equivalent parts in respective figures, and redundant explanations thereof are omitted.

### First Embodiment

### [Overall Configuration]

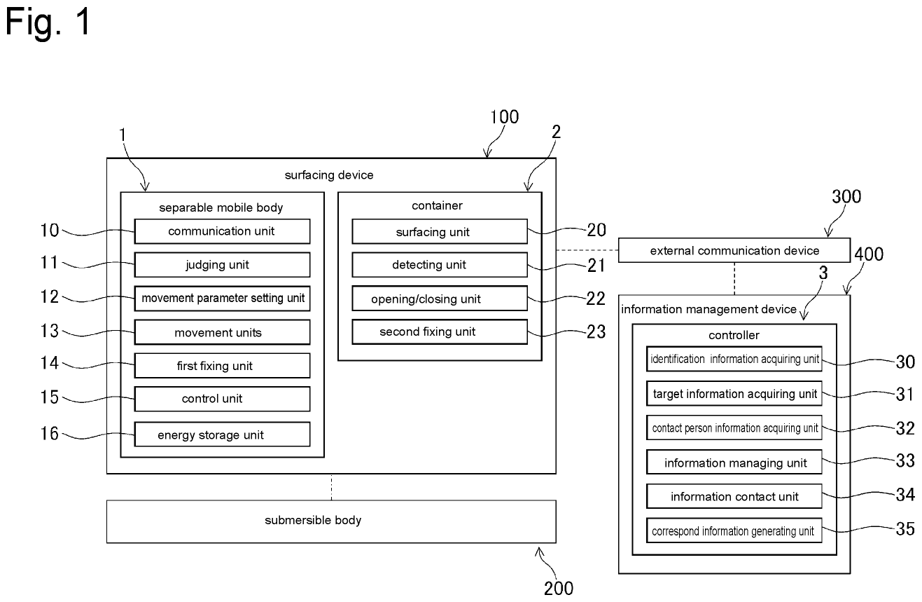

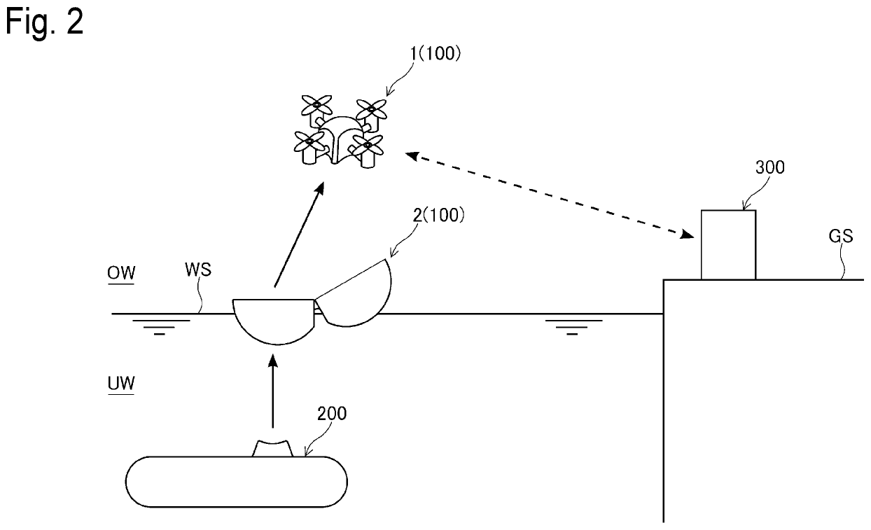

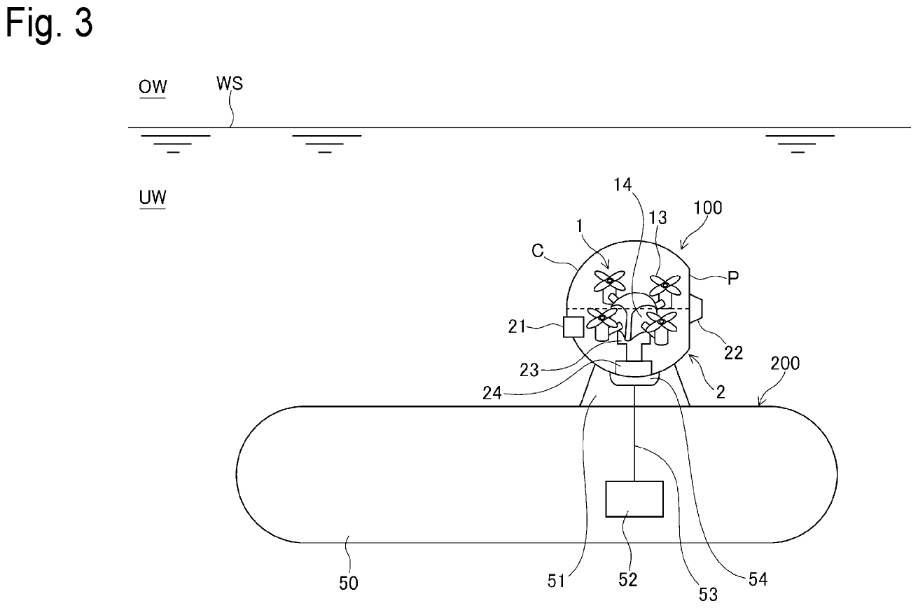

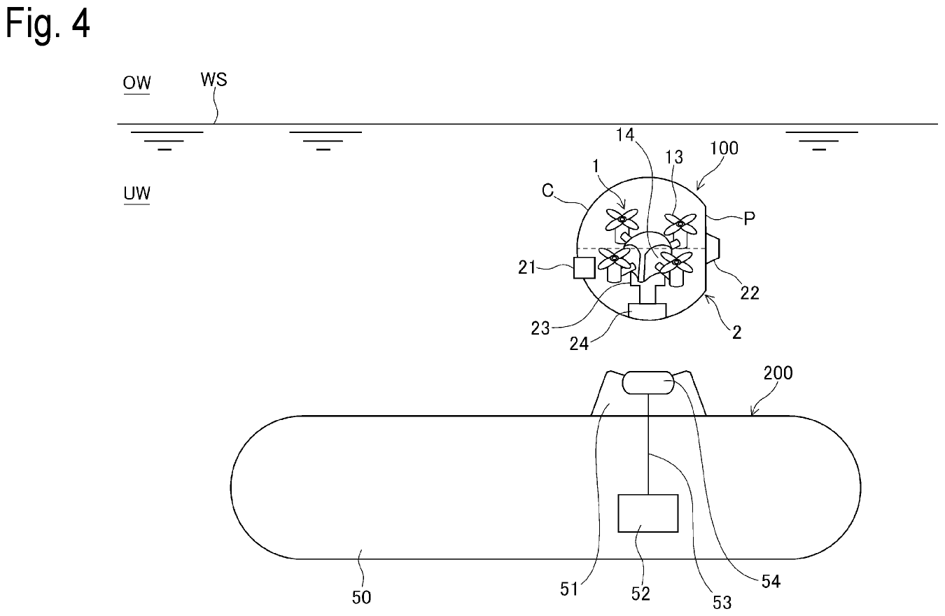

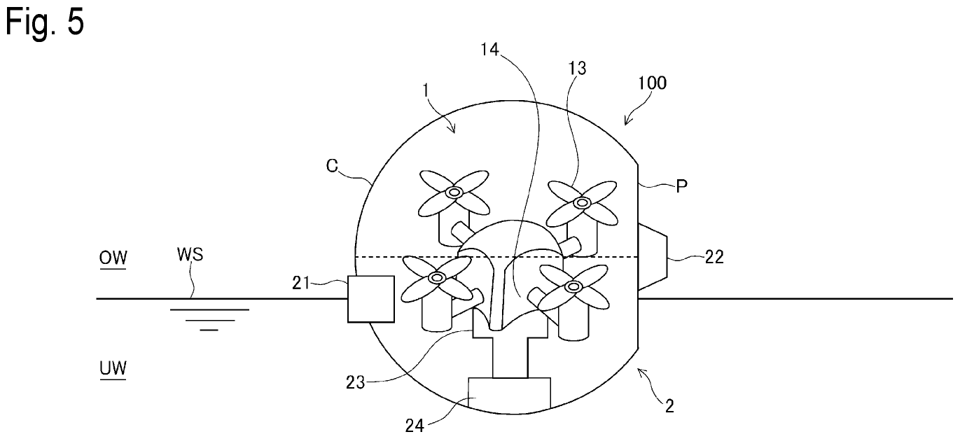

FIG. 1 is a block diagram showing the surfacing device 100 and the information management device 400 of the first embodiment. FIG. 2 shows a communication between the surfacing device 100 and the external communication device 300. FIG. 3 shows the surfacing device 100 mounted on a submersible body 200 submerged in under-water UW. FIG. 4 shows the surfacing device 100 being released from the submersible body 200 and surfacing. FIG. 5 shows the surfacing device 100 surfacing on water OW. As shown in FIG. 1 through FIG. 5, the surfacing device 100 is a device that is released from the submersible body 200 which has been submerged in under-water UW and has surfaced from under-water UW to above-water OW and communicates with the external communication device 300. In other words, the surfacing device 100 is initially mounted or held by the submersible body 200. The information management device 400 is a device that acquires various information on the surfacing device 100 from, for example, the external communication device 300 and manages the information.

Here, the surfacing device 100 is used by the submersible body 200 to transmit distress signals to the external communication device 300. For example, the surfacing device 100 transmits a distress signal to the external communication device 300 to request rescue of crew by the submersible body 200 in the event of an accident or distress in the under-water UW The surfacing device 100 is configured to move to a position where the distress signal can be easily received by the external communication device 300 (by moving at least a part of the surfacing device 100) to enable transmission of the distress signal. Troubles that may occur to the submersible body 200 in the under-water UW include, for example, getting stuck by rocks, engine trouble, sudden illness of crew, running out of fuel, fire blazing, or lack of oxygen.

The use of the surfacing device 100 is not limited to transmitting distress signals (rescue requests), while the signals to be transmitted by the surfacing device 100 to the external communication device 300 are not limited to distress signals. For example, the use of the surfacing device 100 may be a notification that the occupants are safe, or a notification of the surrounding conditions of the submersible body 200, or a report of the results of various investigations performed by the submersible body 200 and others in under-water UW.

Here, “under-water” means a position in water at least below water surface WS. More precisely, “under-water UW” may mean a position submerged in water deeper than water surface WS by a predetermined degree (e.g., 50 cm or 1 m, or the like). As an example of an actual use of the surfacing device 100, the surfacing device 100 may be released from a submersible body 200 that has been submerged in water UW to a depth of about 100 m. The surfacing device 100 may be released from a submersible body 200 that has been submerged in water UW to a depth of about 500 m.

The term “above-water” means near water surface WS. In other words, above-water OW may be a position at a height equivalent to water surface WS, or a position above water surface WS, or a position below water surface WS where the depth (water depth) from water surface WS is less than a certain degree (e.g., 50 cm, or the like). Here, the depth from water surface WS may be measured at the top of the surfacing device 100, or at the center of the surfacing device, or at the center of gravity of the device. The under-water UW and water surface OW may be in contact with each other at the boundary, or the under-water UW and water surface OW may be vertically separated by a separate layer.

“Surfacing from under-water to above-water” means surfacing upward or diagonally upward from under-water UW to above-water OW. “Surfacing” may mean, for example, upward or oblique upward movement by buoyancy, or an upward or oblique upward movement by mechanical propulsion such as screws or thrusters, or an upward or oblique upward movement by other means. The languages “surfacing to above-water” means that an object is in the process of surfacing toward water surface OW and can continue surfacing from that position. On the other hand, “surfacing to above-water” means a condition in which the surfacing to water surface OW has been completed. In other words, this means a state in which the device has surfaced to a position where it will not float upward any further or to a position close to that position. The languages “has floated to above-water” may mean a state in which the surfacing device 100 has floated until at least a part of it is above water surface WS. Here, term “water” may be a water coming from sea, lake, river or the like, or any other water source.

“Submersible body” is a subject capable of submerging in water UW. Specifically, a submersible body 200 may be a submersible, a submarine, a structure or device installed in under-water UW, or a user (diver) who dives into under-water UW. When the submersible body 200 is a submersible or submarine and the like, the submersible body 200 may be a passenger-carrying submersible body or a non-passenger-carrying submersible body that cannot be boarded by a crew member. Here, a submersible body configured as a passenger submersible body is exemplified as the submersible body 200.

The term “released” means that the surfacing device 100 is released from a state in which it is mounted or held by the submersible body 200, and the surfacing device 100 is separated from the submersible body 200. At this time, the surfacing device 100 and the submersible body 200 may be completely separated, or the main body portion of the surfacing device 100 may be separated from the submersible body 200 while maintaining the connection by wires or the like.

For example, when the submersible body 200 is a submersible, a submarine, or a structure or device installed in under-water UW, the surfacing device 100 fixed (mounted) to the submersible body 200 by a fixing mechanism may be released from the submersible body 200 when the fixing mechanism is released. For example, when the submersible body 200 is a user or the like, submerged in under-water UW, the surfacing device 100 held by the submersible body 200 may be released by the submersible body 200.

As mentioned above, in the present embodiment, the submersible body 200 is a diving body configured as a submersible body for boarding. The submersible body 200 is equipped with various devices for use in submersible and navigation or the like (not shown). Further, the submersible body 200 is also equipped with a hull 50, a pedestal 51, a battery 52, a cable 53, and a first fixing mechanism 54.

The hull portion 50 is a portion as the main body of the submersible body 200. The hull portion 50 has a space for crew members to board and the like inside the hull portion 50. The pedestal 51 is provided on the top surface of the hull portion 50 and is a pedestal to which the surfacing device 100 is fixed. Battery 52 is a storage battery for supplying power to a first fixing mechanism 54 and is electrically connected to the first fixing mechanism 54 by cable 53.

The first fixing mechanism 54 is a mechanism for fixing the surfacing device 100 on the pedestal 51 of the submersible body 200. The first fixing mechanism 54 is configured here as an electromagnet, which generates magnetic force when power is supplied from the battery 52. As described below, the surfacing device 100 has a second fixing mechanism 24 made of a magnetic material. As a result, when electric power is supplied to the first fixing mechanism 54 from the battery 52, the electromagnet generates magnetic force, which attracts the second fixing mechanism 24 of the surfacing device 100 to the submersible body 200, while the surfacing device 100 is fixed on the base 51. On the other hand, when the supply of electric power from the battery 52 to the first fixing mechanism 54 is stopped, the electromagnet will stop generating magnetic force and the second fixing mechanism 24 of the surfacing device 100 is no longer attracted to the submersible body 200, causing the surfacing device 100 to be released from the pedestal 51.

The surfacing device 100 is a device that is released from the submersible body 200 and floats from under-water UW to above-water OW, and communicates with the external communication device 300 by moving the target part of the surfacing device 100. The term “target part” is at least a part of the surfacing device 100 that is moved by the movement units 13 described below. The phrase “at least apart of a portion” means that it may be the whole surfacing device 100 (the entire surfacing device 100) or only a part of the surfacing device 100.

The term “movement of the subject portion” may be a movement on water surface WS, or a movement in the air (flight), or a movement on the ground GS. The subject portion may be configured as an amphibious drone that can move through water UW, over water OW, or in the air, or an amphibious drone that can move through water UW, over water OW, or over ground GS.

The volume of the surfacing device 100 is preferably 10000 cm3 or less, more preferably 5000 cm3 or less, and further preferably 3000 cm3 or less, in view of convenience of being mounted (or being carried) on the submersible body 200. The weight of the surfacing device 100 is preferably 5 kg or less, more preferably 3 kg or less, further preferably 1 kg or less, in view of convenience of mounting (or holding) the surfacing device on the submersible body 200 and for the purpose of an easy surfacing (floating upward).

The surfacing device 100 is provided with a separable mobile body 1 and a container 2. The separable mobile body 1 is a device that can be separated from the container 2 and can move with the container 2 regarding the surfacing device 100. In the present embodiment, the separable mobile body 1 corresponds to the target part. Namely, in the present embodiment, the target part is a part of the surfacing device 100, but not all of the device. “Separated” may mean that the separable mobile body 1 may be completely separated from the container 2 without any connection, or it may mean that the separated mobile body 1 is partially separated from the container 2 while maintaining a wire or other connection between the separated mobile body 1 and the container 2. The separated mobile body 1 is a so-called drone (unmanned aerial vehicle), specifically a multi-copter (rotary wing aircraft) provided with a plurality of propellers respectively rotating about a plurality of vertical axes. More specifically, the separated mobile body 1 is a quadcopter with four propellers.

The container 2 has an appearance of a pair of hemispherical containers that can be opened and closed, and is an enclosure for containing the separable mobile body 1 in a sealed state. The terms “sealed state” means that the outer shell is closed to prevent water from entering the interior of the container 2 in under-water UW. The container 2 can accommodate the separated mobile body 1 in a state that shuts it off from the surrounding water, for example, when the surfacing device 100 is located in water UW Specifically, the container 2 maintains the separated mobile body 1 shielded from the surrounding water until the surfacing device 100, which is fixed to the submersible body 200, is released from the submersible body 200 and has surfaced from under-water UW to above-water OW. After the surfacing device 100 is released from the submersible body 200 and has surfaced from under-water UW to above-water OW, the container 2 is unsealed to allow the separated mobile body 1 to be moved (detached) from the inside to the outside. The container 2 may be made of, for example, carbon, glass, acrylic, rubber, plastic, or polyethylene. Further, the container 2 may be a solid object with a definite shape, or it may be a bag-like object with no definite shape.

The container 2 has a curved surface portion C and a non-curved surface portion P. The “curved surface portion” is a portion whose outer surface is composed of a curved surface. The “non-curved surface portion” is a portion whose outer surface consists of a flat surface. The non-curved surface portion P may have an outer surface composed of concave-convex surface including several planar surfaces. Here, the non-curved surface portion P is a portion where a hinge of the opening/closing portion 22 described below is provided. The curved surface portion C is a portion other than the non-curved surface portion P, and is configured to form part of the sphere.

The maximum length of the container 2 is preferably less than 30 cm, more preferably less than 25 cm, and even more preferably less than 20 cm. This compact configuration of the container 2 improves the convenience of carrying and mounting the container. The container 2 is also configured so that the average density is 2.0 g/cm3 or less. The “average density of the container” is an average density calculated without including the space inside the container 2 into the volume of the container 2. By configuring the density of the container 2 in this way, the weight of the container can be reduced. This also improves the convenience of carrying the container 2.

The functional configuration of the container 2 will be described below. The container 2 has a surfacing unit 20, a detecting unit 21, an opening/closing unit 22, and a second fixing unit 23.

The surfacing unit 20 raises the surfacing device 100 released from the submersible body 200 from under-water UW to above-water OW. The means by which the surfacing unit 20 raises the surfacing device 100 (i.e., a specific manner in which the surfacing unit 20 is used) is not particularly limited. For example, the surfacing unit 20 may be a propeller (e.g., thruster or screw) to raise the surfacing device 100. Alternatively, the surfacing unit 20 may be a structural part to make the density (average density) of the surfacing device 100 smaller than the density of water so that the surfacing device 100 floats on water. Specifically, the surfacing unit 20 may be a structural part to reduce the weight of the surfacing device 100 or to increase the amount of air sealed in the surfacing device 100 (i.e., the volume of the surfacing device 100). Here, the surfacing unit 20 may also be an air introduction mechanism that introduces air into the sealed container 2. Further, the surfacing unit 20 does not have to refer to a specific part of the surfacing device 100, and may for example refer to the surfacing device 100 itself, which is configured with a density less than the density of water. The “density of water” may be the density of fresh water or seawater, which is salt water.

The detecting unit 21 detects that the surfacing device 100 has surfaced from under-water UW to above-water OW. More precisely, the detecting unit 21 detects that the surfacing device 100 has reached above-water OW by surfacing from under-water UW using the surfacing unit 20. The means by which the detecting unit 21 detects that the surfacing device 100 has surfaced from under-water UW to above-water OW (i.e., a specific mode of the detecting unit 21) is not particularly limited. For example, the detecting unit 21 may be a camera or a water pressure sensor.

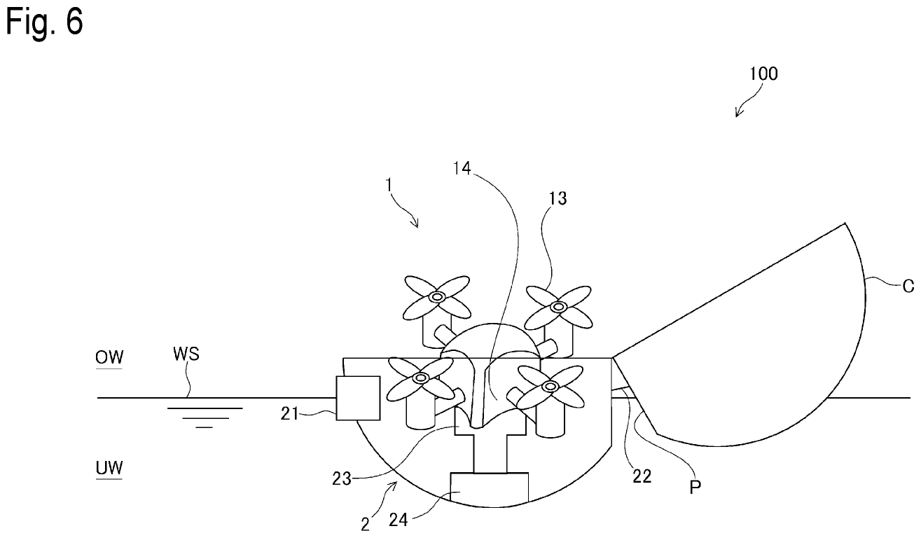

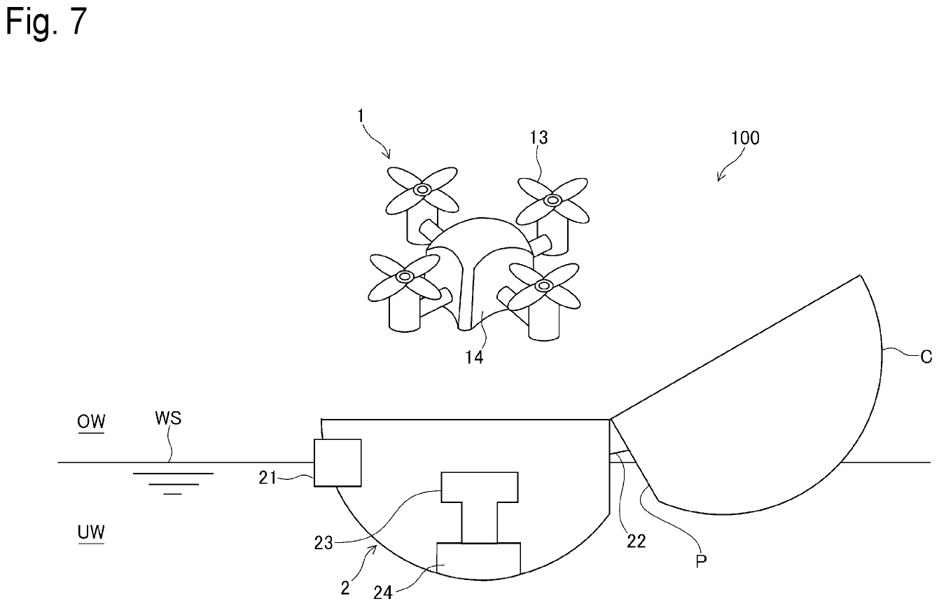

FIG. 6 shows the surfacing device 100 with the opening/closing portion 22 of the container 2 in its open state. FIG. 7 shows the container 2 with the opening/closing portion 22 in its open state and also shows the separated mobile body 1 that has started flying from the container 2. As shown in FIG. 1 through FIG. 7, the opening/closing portion 22, when closed, seals the interior of the container 2, and when opened, unseals the interior of the container 2 and allows the separated mobile body 1 to move from the interior to the exterior of the container 2. In other words, the container 2 can contain the separated mobile body 1 in a sealed state when the opening/closing portion 22 is closed, and can release the sealed state and move the separated mobile body 1 from the inside to the outside when the opening/closing portion 22 is opened. “Closed state” means that the inside of the container 2 is sealed and shut off from surrounding water. In the closed state, the container 2 has a volume that can accommodate the separated mobile body 1. On the other hand, “open state” means a state in which the interior of the container 2 is unsealed and the space inside the container 2 is open to the outside. In an open state, the container 2 may have a pair of hemispherical containers open to each other so that the separated mobile body 1 housed inside can exit to the outside. The opening/closing portion 22 may be automatically opened and closed by an electrically operated mechanism.

The mechanism by which the container 2 is opened and closed by the opening/closing portion 22 (closing mechanism) is realized here by a pair of hemispherical containers being connected to each other by a hinge. On the other hand, the opening and closing mechanism may be such that the lid portion slides to open and close the container 2. The mechanism by which the container 2 is brought from the closed state to the open state by the opening/closing portion 22 (opening mechanism) may be achieved by blowing up at least a part of the container 2 with an explosive to bring the container 2 from the closed state to the open state, or by melting at least a part of the container 2 by using a heat of a flame. Further, the container 2 may also be brought from the closed state to the open state by applying a force such as elasticity using a spring.

The opening/closing portion 22 may, for example, be brought from the closed state to the open state when it is detected by the detection portion 21 that the surfacing device 100 has surfaced from under-water UW to above-water OW. In other words, the container 2 may have the opening/closing portion 22 to be brought from the closed state to the open state when the detecting unit 21 detects that the surfacing device 100 has emerged from under-water UW to above-water OW. On the other hand, the opening/closing unit 22 may be brought from the closed state to the open state when a predetermined time has elapsed from a specific timing.

The second fixing unit 23 is a mechanism that enables the separated mobile body 1 and the container 2 to be fixed to each other when the separated mobile body 1 is housed inside the container 2. The second fixing unit 23 may cooperate with the first fixing unit 14 (to be described below) of the separated mobile body 1 to fix the separated mobile body 1 and the container 2 to each other. The second fixing unit 23 is configured here as an electromagnet, which generates a magnetic force when an electric power is supplied. The second fixing unit 23 may be powered by the battery 52 or by another battery. As described below, the separated mobile body 1 has a first fixing unit 14 made of a magnetic material. When electric power is supplied to the second fixing unit 23, an electromagnet generates a magnetic force, which attracts the first fixing unit 14 of the separated mobile body 1 to the second fixing unit 23 of the container 2, thereby fixing the separated mobile body 1 to the container 2. On the other hand, when the supply of electric power to the second fixing unit 23 is stopped, the electromagnet no longer generates magnetic force, and the first fixing unit 14 of the separated mobile body 1 is no longer attracted to the second fixing unit 23 of the container 2, allowing the separated mobile body 1 to move from the container 2. Here, the second fixing unit 23 may be located on the top of the platform on which the separated mobile body 1 is placed.

The container 2 also has a second fixing mechanism 24. The second fixing mechanism 24 is a mechanism for fixing the surfacing device 100 on the base 51 of the submersible body 200 in cooperation with the first fixing mechanism 54. The second fixing mechanism 24 is composed of a magnetic material. Therefore, as described above, when electric power is supplied from the battery 52 to the first fixing mechanism 54 (which is configured as an electromagnet), a magnetic force is generated and the surfacing device 100 is fixed to the pedestal 51. On the other hand, when the supply of electric power from the battery 52 to the first fixing mechanism 54 is stopped, the magnetic force will disappear and the surfacing device 100 is released from the pedestal 51, making it possible for the surfacing device 100 to float upward.

The container 2 may further have a control device, which is not shown in the figure. This control device may control the surfacing unit 20, the detecting unit 21, the opening/closing unit 22, the second fixing unit 23, and the like. In this case, the control device may be electrically connected by wired or wireless means to the various devices including the surfacing unit 20, the detecting unit 21, the opening/closing unit 22, and the second fixing unit 23 or the like to exchange signals. Alternatively, the container 2 may be electrically connected to the control unit 15 (to be described below) of the separated mobile body 1, and the control unit 15 may perform the same functions as the control unit described above.

The separated mobile body 1 will be described below. The separated mobile body 1 is part of the surfacing device 100 and has a communication unit 10, a judgment unit 11, a movement parameter setting unit 12, movement units 13, a first fixing unit 14, a control unit 15, and an energy storage unit 16. The separated mobile body 1 is also equipped with various configurations as a drone. For example, the separated mobile body 1 may be equipped with a propeller, a flight controller, a battery, a base, a communication module, a storage unit, a camera, a GNSS (Global Navigation Satellite System) receiver, an acceleration sensor, a gyro sensor, a barometric sensor, an infrared sensor. The GNSS receiver may be for example a GPS (Global Positioning System) receiver. The mobile body 1 is separated from the container 2 (which is the remaining portion of the surfacing device 100) and moved by the movement units 13 after the surfacing device 100 has surfaced from under-water UW to above-water OW, as described below.

The communication unit 10 communicates with the external communication device 300 after the surfacing device 100 has surfaced from under-water UW to above-water OW. More precisely, the communication unit 10 communicates with the external communication device 300 after the separated mobile body 1 starts flying by the movement units 13, as will be described later. For example, the communication unit 10 may communicate with the external communication device 300 when the separated mobile body 1 is flying at an altitude of 15 m or higher by the movement units 13. By communicating in this manner at a position higher than water surface WS, the sight distance (possible communication distance) may be longer than when communicating at the height of water surface WS. The communication unit 10 may communicate with the external communication device 300 at least after the separated mobile body 1 starts flying by the movement units 13, and may communicate with the external communication device 300 even before the separated mobile body 1 starts flying by the movement units 13.

Here, the altitude at which the separated mobile body 1 is flying may be defined as a height (vertical distance) from water surface WS if water surface WS is directly below the separated mobile body 1. In this case, when the vertical position of water surface WS fluctuates due to water waves, the altitude at which the separated mobile body 1 is flying may be defined by a height from any position of the fluctuating water surface WS. The altitude at which the separated mobile body 1 is flying may be defined by a height (vertical distance) from the ground GS when the ground GS is directly below the separated mobile body 1. An altitude at which the separated mobile body 1 is flying may be obtained based on the atmospheric pressure measured by the barometric sensor. The target altitude to be reached by the separated mobile body 1 may be predetermined (e.g., 15 m, 100 m, and the like), or it may be set to increase an altitude without setting any limit. On the other hand, the separated mobile body 1 may be preferably set at 15 m or more as the target altitude to be reached, more preferably may be set at 50 m or more as the target altitude to be reached, and even more preferably may be set at 100 m or more as the target altitude to be reached.

The term “communication” may mean transmitting information, or receiving information. In other words, the communication unit 10 may only be capable of transmitting information to the external communication device 300 or the like, or it may be capable of transmitting information to or receiving information from the external communication device 300 or the like. The information communicated to and from the external communication device 300 by the communication unit 10 may be referred to as target information. For example, the communication unit 10 may be capable of transmitting the target information to the external communication device 300 after the surfacing device 100 has surfaced from under-water UW to above-water OW. The term “communication with the external communication device” may include a case where the external communication device 300 is unable to receive information (fails to receive information) as a final result in a process where the communication unit 10 is transmitting the information.

“Target information” refers to various types of information transmitted from the surfacing device 100 to the external communication device 300. Specifically, the target information may include location information. The “location information” is information indicating the position of at least one of the submersible body 200 and the surfacing device 100, and may include, for example, at least one of latitude, longitude, water depth, and altitude.

When the target information includes location information, the location information of the surfacing device 100 (e.g., the separated mobile body 1) may be obtained based on positioning data from a GNSS receiver mounted on the surfacing device 100 (e.g., the separated mobile body 1). On the other hand, the position information of the submersible body 200 may be estimated by calculating the direction and distance traveled by the submersible body 200 using data from an acceleration sensor or the like with reference to the diving start point, or may be estimated for water depth using data from a pressure sensor or the like. The position information of the submersible body 200 may be transmitted from the submersible body 200 to the surfacing device 100 before the surfacing device 100 is released from the submersible body 200.

The target information may also include status information. The “status information” is information indicating the status of the submersible body 200, and may include, for example, information indicating that the submersible body 200 is “in distress,” “an emergency situation is occurring,” “the crew is in mortal danger,” “the crew is injured,” and the like. Alternatively, the status information may be expressed as a value, number, symbol, or icon depending on the urgency of the condition and the like. The status information of the submersible body 200 may be transmitted from the submersible body 200 to the surfacing device 100 before the surfacing device 100 is released from the submersible body 200.

The target information may include information other than the information described above. For example, the target information may include information regarding a rescue request, weather information, video or still images of the surroundings of the submersible body 200, video or still images of the surroundings of the surfacing device 100, voice, message text, air temperature, or water temperature, and the like.

The target information may have any data volume, but may preferably have a data volume of 1 B or more and 50 B or less, more preferably 1 B or more and 30 B or less, and even more preferably 1 B or more and 12 B or less. By reducing the data volume of the target information in this way, the distance over which the target information can be transmitted can be increased. If the data volume of the target information is about 30 B or 50 B, it is possible to include information such as location information, status information, and message text. On the other hand, if the data volume of the target information is 1 B or more and 12 B or less, it will be easier to comply with the standards of various available communication methods.

The communication unit 10 may communicate with the external communication device 300 using any communication method. For example, LTE, 5G, Wi-Fi, LPWA (e.g., LoRa, Sigfox, ELTRES, or the like), or satellite communication are examples of communication methods used by the surfacing device 100. The communication unit 10 may include an antenna and a communication control unit that communicates with the outside world using an antenna.

The communication unit 10 may communicate with the external communication device 300 by means of radio waves each having a frequency of 1000 MHz or lower. By lengthening the wavelength of the radio waves used for communication in this way, the distance over which the target information can be transmitted can be lengthened.

When transmitting information to the external communication device 300, the communication unit 10 may repeat transmitting the information several times. In particular, the communication unit 10 may pre-set the number of times to transmit the information, or may repeatedly transmit the information until the judgment unit 11 (to be described below) determines that the transmitted information has been received by the external communication device 300. The communication unit 10 may transmit information to the external communication device 300 at predetermined time intervals, for example, once every 30 seconds or once every minute.

The communication unit 10 may transmit the target information to the external communication device 300 until the energy available to the communication unit 10 for transmitting the target information to the external communication device 300 is exhausted (among the energy available to the surfacing device 100). For example, the energy available to the surfacing device 100 may be the energy stored in the energy storage unit 16 (to be described below) of the separated mobile body 1 and available to the separated mobile body 1. The energy available to the communication unit 10 for transmitting the target information to the external communication device 300 may be all the energy stored in the energy storage unit 16 until the energy stored in the energy storage unit 16 becomes zero, or may be a predetermined amount of energy stored in the energy storage unit 16 that is to be distributed in advance for different uses.

The communication unit 10 may be capable of selecting at least two modes of communication with the external communication device 300: a normal communication mode and a test communication mode. In other words, the communication unit 10 may be capable of selecting a test communication mode. The “normal communication mode” is a mode that is selected when the surfacing device 100 is actually in operation. Test communication mode” is a mode in which test information is sent to the external communication device 300 to confirm the operation of the communication unit 10. When the communication unit 10 selects the test communication mode, it may, for example, transmit test information to the external communication device 300. The “test information” is information indicating that the test communication mode has been selected, and may specifically be a predetermined text or a number.

The judging unit 11 judges whether or not the external communication device 300 has received the target information transmitted to the external communication device 300 by the communication unit 10. For example, when the judging unit 11 receives the reception confirmation information after the target information is transmitted to the external communication device 300 by the communication unit 10, the judging unit 11 may determine that the external communication device 300 has received the target information transmitted to the external communication device 300 by the communication unit 10. Further, on the other hand, when the reception confirmation information is not received after the target information is transmitted to the external communication device 300 by the communication unit 10, the judging unit 11 may determine that the external communication device 300 has not received the target information transmitted to the external communication device 300 by the communication unit 10. Here, the “reception confirmation information” is, for example, a kind of information that the external communication device 300 sends to the surfacing device 100 (communication unit 10) upon receiving the target information from the communication unit 10.

The movement parameter setting unit 12 sets movement parameters relating to the movement of the separated mobile body 1. The “movement parameter” is a parameter indicating at least one of distance, altitude, and time over which the separated mobile body 1 should move. The movement parameters may also include parameters other than distance, altitude, and time. For example, the movement parameters may include a direction, a path, or a speed over which the separated mobile body 1 should move.

The distance that the separated mobile body 1 should move may be specified, for example, to be 100 m, 500 m, or 3 km. In this case, the distance may be a distance in one dimension (i.e., a straight line), or a distance in two dimensions (i.e., a horizontal distance integrated along the path of movement of the separated mobile body 1 with respect to latitude and longitude), or a distance in three dimensions (i.e., a spatial distance integrated along the path of movement of the separated mobile body 1 with respect to latitude, longitude, and altitude).

The altitude at which the separated mobile body 1 should move may be specified, for example, to be 15 m, 50 m, or 100 m, and the like. When a predetermined altitude is specified by the movement parameters, the separated mobile body 1 may suppress a change in altitude by hovering (for example), and remain at the predetermined altitude when it has reached the predetermined altitude. Alternatively, when the separated mobile body 1 reaches the predetermined altitude if the predetermined altitude is specified in the movement parameters, it may stop the movement of the movement units 13 (to be described below) and may fall downwards, or it may control the movement of the movement units 13 to effect a descend gradually and land on water surface WS (or land on the ground GS).

The time that the separated mobile body 1 should move may be specified to be, for example, 3 minutes, 10 minutes, or 30 minutes. When a predetermined time is specified in the movement parameters, the separated mobile body 1 may restrain its movement by hovering, and remain at the position when the predetermined time has elapsed. Alternatively, when a predetermined time is specified in the movement parameter, and if the predetermined time has elapsed, the separated mobile body 1 may stop the movement of the movement units 13 (to be described below) and it will fall downward, or it may descend gradually by controlling the movement of the movement units 13 and land on water surface WS (or on the ground GS).

The movement parameter setting unit 12 may set predetermined movement parameters. The movement parameter setting unit 12 may also set movement parameters specified by a user. For example, the movement parameter setting unit 12 may set movement parameters based on information input from a terminal operated by the user. Alternatively, the movement parameter setting unit 12 may set the movement parameters based on information input by the user via the submersible body 200.

The movement parameter setting unit 12 may set the movement parameters based on whether the normal or test movement mode is selected by the movement units 13, as described below. In this case, in the test movement mode, the distance that the separated mobile body 1 should move may be shorter, the altitude that the separated mobile body 1 should move may be lower, and the time that the separated mobile body 1 should move may be shorter than in the normal movement mode.

The movement units 13 move the target part (which is at least a part of the surfacing device 100) after the surfacing device 100 has been raised from under-water UW to above-water OW. Here, since the target part is the separated mobile body 1, the movement units 13 can be rephrased as moving the separated mobile body 1 (after the surfacing device 100 has surfaced from under-water UW to above-water OW). In other words, the separated mobile body 1 can be read here as the target part. Specifically, the movement units 13 move the separated mobile body 1 by causing it to fly.

The movement units 13 move the separated mobile body 1 according to the movement parameters set by the movement parameter setting unit 12. The movement units 13 may be able to select at least two modes when moving the separated mobile body 1, e.g., a normal movement mode and a test movement mode. In other words, the movement units 13 can select the test movement mode. The “normal movement mode” is a mode that is selected when the surfacing device 100 is actually in operation. The “test moving mode” is a mode in which the separated mobile body 1 is test-moved to confirm the operation of the movement units 13. For example, in the test movement mode, the distance, altitude, and time may be smaller in their set values than in the normal movement mode. The movement units 13 may also select the normal movement mode or the test movement mode based on the movement parameters set by the movement parameter setting unit 12.

When the test movement mode is selected by the movement units 13, the test communication mode may be selected by the communication unit 10 at the same time. In other words, both the test movement mode and the test communication mode may be set simultaneously.

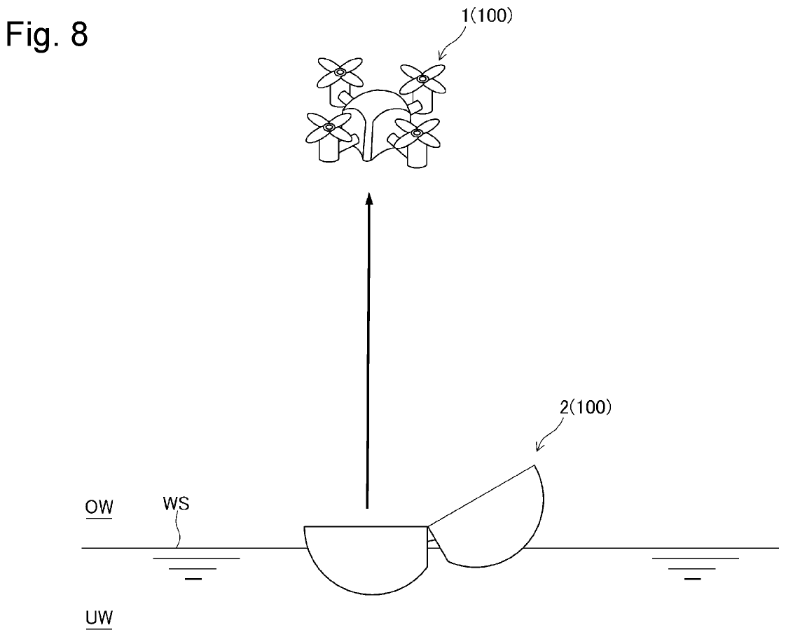

FIG. 8 shows the separated mobile body 1 being propelled upward from the container 2. As shown in FIG. 1 through FIG. 8, the movement units 13 can move the separated mobile body 1 in a variety of ways depending on the movement parameters. For example, the movement units 13 may cause the separated mobile body 1 to fly by generating an upward propulsive force that propels the separated mobile body 1 upward. In this case, the separated mobile body 1 may be allowed to be swept horizontally under the influence of wind or other factors without generating a lateral propulsive force that propels the separated mobile body 1 in a lateral (horizontal) direction, while at the same time moving the separated mobile body 1 toward a vertical upward direction. Accordingly, energy for the lateral propulsive force can be saved. Further, the movement units 13 may also generate lateral propulsive force in addition to upward propulsive force.

The movement units 13 may move the separated mobile body 1 in a specific direction. The “specific direction” may mean a direction in a specific direction, a direction toward a specific latitude and longitude, a direction toward a specific address, a direction toward the location of the external communication device 300 (base station) stored in advance, or a direction toward vertical upward direction.

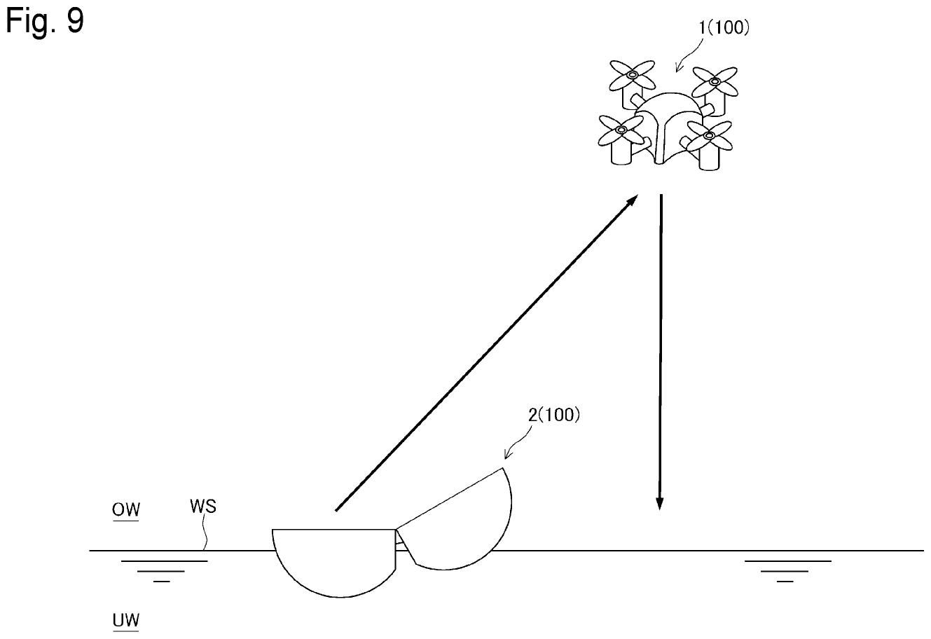

FIG. 9 shows the separated mobile body 1 descending from a state of flight to a state of heading directly downward. As shown in FIG. 9, the movement units 13 may cause the separated mobile body 1 in flight to descend so as to head directly downward. The term “direct-below” does not have to be strictly directly below the separated mobile body 1. For example, a predetermined range centered strictly below the separated mobile body 1 (e.g., within a radius of 1 m, 5 m, or 10 m) may be considered to be direct-below. The movement units 13 may cause the separated mobile body 1 to descend toward “direct-below” after the target information is transmitted to the external communication device 300 by the communication unit 10 while the separated mobile body 1 is in flight.

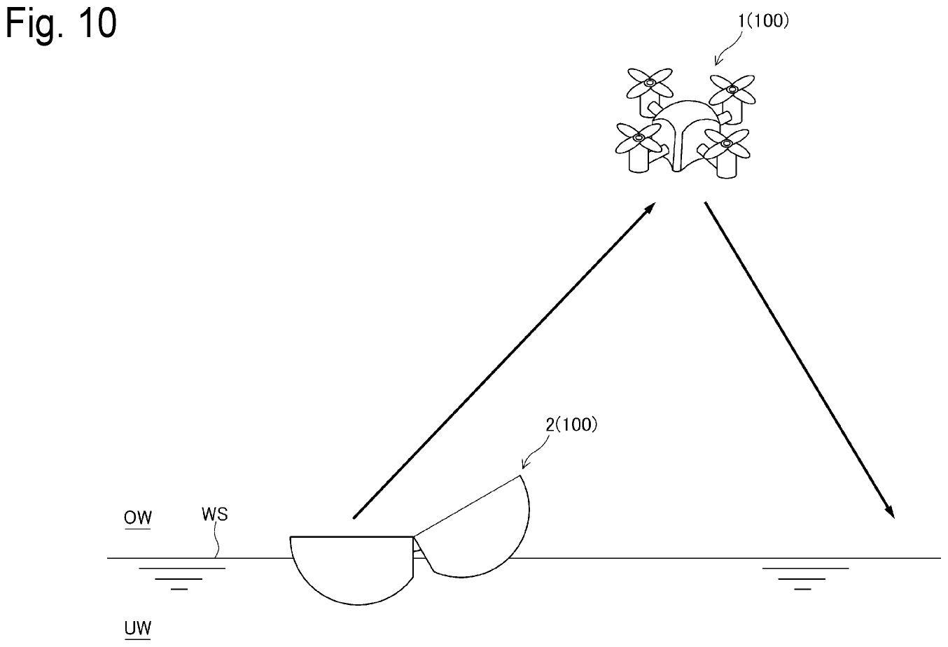

FIG. 10 shows the separated mobile body 1 descending from a flying state to a position different from direct-below. As shown in FIG. 10, the movement units 13 may cause the separated mobile body 1 in flight to descend so as to head toward a position different from direct-below. The languages “position different from direct-below” may be, for example, a position outside a predetermined range centered strictly directly below the separated mobile body 1 (e.g., outside a radius of 1 m, 5 m, or 10 m). “Toward a position different from direct-below” may mean toward a predetermined position, or toward a position different from direct-below as a result of not actively intending to head directly below. The movement units 13 may cause the separated mobile body 1 to descend toward a position different from direct-below after the target information is transmitted to the external communication device 300 by the communication unit 10 while the separated mobile body 1 is in flight.

Returning to FIGS. 1 to 8, the movement units 13 may not move the separated mobile body 1 when it is determined by the determining unit 11 that the target information has been received by the external communication device 300 (i.e., when communication has been successful). More precisely, when the target information has been transmitted by the communication unit 10 to the external communication device 300 after the surfacing device 100 has surfaced from under-water UW to above-water OW and before the separated mobile body 1 is separated from the container 2 and has moved, and when it is determined by the judgment unit 11 that the external communication device 300 has received the target information, the movement units 13 do not have to move the separated mobile body 1. Alternatively, the movement units 13 may not move the separated mobile body 1 when the target information is transmitted to the external communication device 300 for a predetermined number of times (e.g., 20 or 50 times), or when the target information is transmitted to the external communication device 300 for a predetermined time (e.g., 5 or 10 minutes).

The movement units 13 may allow the separated mobile body 1 in flight to remain in the same position after the target information is transmitted to the external communication device 300 by the communication unit 10. “Staying at the same position” may mean suppressing changes in altitude, as well as changes in latitude and longitude, for example by hovering. The movement units 13 may make the separated mobile body 1 in flight to stay at the same position when it is determined by the determining unit 11 that the target information has been received by the external communication device 300 (i.e., when the communication has been successful). Alternatively, the movement units 13 may make the separated mobile body 1 in flight to stay at the same position when the target information is transmitted to the external communication device 300 for a predetermined number of times (e.g., 20 or 50 times or the like), or the separated mobile body 1 in flight may be made to remain in the same position when the target information is transmitted to the external communication device 300 for a predetermined time (e.g., 5 or 10 minutes).

The movement units 13 may stop operation after the target information has been transmitted to the external communication device 300 by the communication unit 10. “Stopping the operation” may mean, for example, stopping the power of a propeller or the like, and in this case, the separated mobile body 1 in flight may fall. The movement units 13 may also stop operation when it is determined by the judgment unit 11 that the target information has been received by the external communication device 300 (i.e., when the communication is successful). Alternatively, the movement units 13 may stop operation when the target information is transmitted to the external communication device 300 for a predetermined number of times (e.g., 20 or 50 times or the like) or when the target information is transmitted to the external communication device 300 for a predetermined times (e.g., 5 or 10 minutes or the like).

The movement units 13 may move the separated mobile body 1 until the energy available to the movement units 13 for moving the separated mobile body 1 (among the energy available to the surfacing device 100) is exhausted. For example, the energy available to the surfacing device 100 may be the energy stored in the energy storage unit 16 (to be described below) and available to the separated mobile body 1. The energy available to the movement units 13 for moving the separated mobile body 1 may be all the energy stored in the energy storage unit 16 until the energy stored in the energy storage unit 16 becomes zero, or it may be a predetermined amount of energy stored in the energy storage unit 16 that is allocated in advance for different uses.

The first fixing unit 14 is a mechanism that enables the separated mobile body 1 and the container 2 to be fixed to each other when the separated mobile body 1 is housed inside the container 2. The first fixing unit 14 may cooperate with the second fixing unit 23 of the container 2 to fix the separated mobile body 1 and the container 2 to each other. The first fixing unit 14 is composed of a magnetic material. Therefore, as described above, when electric power is supplied to the second fixing unit 23 (which is configured as an electromagnet), a magnetic force is generated and the separated mobile body 1 is fixed to the container 2. On the other hand, when the supply of electric power to the second fixing unit 23 is stopped, the magnetic force disappears and the separated mobile body 1 is released from the container 2 and can thus be moved.

The control unit 15 controls the communication unit 10, the judgment unit 11, the movement parameter setting unit 12, the movement units 13, the first fixing unit 14, and the energy storage unit 16 and the like which will all be described below. In this case, the control unit 15 may be electrically connected by wired or wireless means to the various devices including the communication unit 10, judgment unit 11, movement parameter setting unit 12, movement units 13, first fixing unit 14, and energy storage unit 16 or the like, thereby performing various signal exchanges.

The energy storage unit 16 stores energy for operating various devices of the surfacing device 100 and supplies energy to other devices as needed. The energy storage unit 16 may be capable of supplying energy to each of the various devices of the separated mobile body 1 and the various devices of the container 2 when the separated mobile body 1 is fixed to the container 2. The energy storage unit 16 may be capable of supplying energy to various devices of the separated mobile body 1 when the separated mobile body 1 is released from the container 2. Here, the energy storage unit 16 is a battery that stores (accumulates) electric power.

The energy storage unit 16 is not limited to a battery, but may also be a fuel tank that stores fuel such as gasoline. When supplying energy to the various devices of the surfacing device 100, the separated mobile body 1 may generate energy and directly supply the generated energy to the devices concerned, rather than supplying energy stored in the energy storage unit 16 to the devices concerned. For example, the separated mobile body 1 may have a solar panel instead of the energy storage unit 16, and the power generated by the solar panel may be directly supplied to the various devices of the surfacing device 100.

The separated mobile body 1 thus configured floats from under-water UW to above-water OW with the surfacing device 100 housed inside the container 2 where the opening/closing portion 22 is closed, and after the opening/closing portion 22 is opened, the surfacing device 100 is separated from the container 2 and caused to fly (move) by the movement units 13. More precisely, when the separated mobile body 1 is housed in the interior of the container 2 with the opening/closing portion 22 closed, the surfacing device 100 will surface from under-water UW to above-water OW, and the opening/closing portion 22 is opened. Further, the fixation with the container 2 by the first fixing unit 14 and the second fixing unit 23 are released. Under such a condition, the surfacing device 100 is separated from the container 2 and caused to fly (move) by the movement units 13.

Next, the external communication device 300 will be described. Here, the external communication device 300 is a communication base station capable of wired or wireless communication with the surfacing device 100 and the information management device 400. The external communication device 300 may be configured to communicate with each of the surfacing device 100 and the information management device 400 via a network. Further, the external communication device 300 may be installed above the ground GS. In fact, the external communication device 300 is not limited to a communication base station, but may be, for example, a receiver installed in a terminal, or may be a satellite.

When the external communication device 300 receives target information from the surfacing device 100, it may generate reception confirmation information indicating that it has received the target information and may transmit the generated reception confirmation information to the surfacing device 100. Further, when the external communication device 300 receives the target information from the surfacing device 100, it may transmit the target information to the information management device 400. In this case, the external communication device 300 may transmit the target information to the information management device 400 immediately after receiving the target information, or it may transmit all the target information to the information management device 400 until a predetermined timing after receiving the target information.

Next, the information management device 400 will be described. Here, the information management device 400 is a device that manages information for each of the submersible body 200 and the surfacing device 100. Further, the information management device 400 is configured as a computer (server) capable of wired or wireless communication with the external communication device 300 and the user terminal. The information management device 400 has a control processor, a storage device, and an input/output device as its physical configuration. The control arithmetic unit is composed of a controller 3 such as a CPU (Central Processing Unit), which executes arithmetic processing and controls the storage device and input/output device. The storage device has, for example, a main memory and an auxiliary memory. The main memory is composed of, for example, RAM (Random Access Memory). The auxiliary storage device is composed of, for example, ROM (Read Only Memory). The input/output device has, for example, an input device that inputs data from the outside and transmits it to the storage device, and an output device that outputs the calculation results calculated by the control arithmetic unit and stored in the storage device to the outside.

The information management device 400, for example, reads a program stored in ROM into RAM and executes the program read into RAM by the CPU to perform a predetermined processing. The computer comprising the information management device 400 may physically have a configuration different from that described above.

Next, the functions of the information management device 400 will be described. The controller 3 of the information management device 400 is functionally equipped with an identification information acquisition unit 30, a target information acquisition unit 31, a contact information acquisition unit 32, an information management unit 33, an information communication unit 34, and a corresponding information generating unit 35.

The identification information acquiring unit 30 acquires identification information concerning the surfacing device 100. The “identification information” may be an ID for identifying the surfacing device 100, or the submersible body 200 pertaining to the surfacing device 100, or the individual itself of the separated mobile body 1. The identification information may also be IDs of various devices or modules included in the separated mobile body 1. The identification information acquisition unit 30 may acquire the identification information based on information input from a terminal operated by a user. Alternatively, the identification information acquisition unit 30 may acquire the identification information based on information input by the user via the submersible body 200.

The target information acquiring unit 31 acquires target information transmitted to the external communication device 300 by the communication unit 10 provided in the surfacing device 100. More precisely, the target information acquisition unit 31 acquires the target information by receiving the target information from the external communication device 300, once the target information is transmitted to the external communication device 300 by the communication unit 10.

The contact information acquiring unit 32 acquires contact information about the submersible body 200. The “contact information” refers to contact information regarding the submersible body 200, which may be, for example, contact information of the crew or owner of the submersible body 200 or their related persons. The contact information may be, for example, a telephone number, e-mail address, address or the like. The “concerned parties” may be family members, rescue teams, safety management companies, public agencies or the like. The contact information acquisition unit 32 may acquire contact information based on information input from a terminal operated by the user. Alternatively, the contact information acquisition unit 32 may acquire contact information based on information input by the user via the submersible body 200.

The information management unit 33 manages the identification information acquired by the identification information acquiring unit 30 and the target information acquired by the target information acquiring unit 31 by linking them to each other. The information management unit 33 may also manage the contact information acquired by the contact information acquisition unit 32, by linking the contact information with the identification information. Here, “managing information” may include storing the information in a storage device or storage medium, updating the stored information, or displaying the stored information on a terminal screen. In addition to identification information, target information, and contact information, the information management unit 33 may manage information, such as the location of the rescue request (e.g., latitude, longitude, and depth, address, and landmarks on a map), a time at which the information was transmitted, and the rescue status (e.g., w rescue request, waiting for rescue, or under rescue).

When new target information is acquired by the target information acquisition unit 31, information contact unit 34 contacts the contact person associated with the target information based on the contact information associated with the identification information tied to the target information. At this time, the information contact unit 34 may, for example, call, e-mail, notify, on a website or an application or the like, the contact persons via the input/output device of the information management device 400. The information contact unit 34 may contact the contact person in particular when the target information newly acquired by the target information acquisition unit 31 is a kind of information indicating that the submersible body 200 is in danger due to distress or the like (crisis information).

After the target information is acquired by the target information acquisition unit 31, the corresponding information generation unit 35 generates corresponding information regarding the response to the submersible object 200. The “corresponding information” may be a kind of information such as “rescue request incomplete,” “rescue request in progress,” “rescue request complete,” “rescue operation in progress,” “submersible body found,” “rescue complete,” or “submersible body retrieval complete”. The corresponding information generation unit 35 may automatically generate corresponding information based on contact with the rescue team or the like, or it may generate corresponding information based on information entered by an administrator (information entered by text, information entered by pull-down, or the like).

### [Actions and Effects]

As explained above, the surfacing device 100 is a device 100 that is released from the submersible body 200 submerged in under-water UW, surfaces to above-water OW and communicates with the external communication device 300, including: a surfacing unit 20 that rases the surfacing device 100 released from the submersible body 200 from under-water UW to above-water OW; a communication unit 10 capable of transmitting target information to the external communication device 300 after the surfacing device 100 has surfaced from under-water UW to above-water OW; and movement units 13 that move the target part (which is at least a part of the surfacing device 100) after the surfacing device 100 has surfaced from under-water UW to above-water OW.

According to this surfacing device 100, after the surfacing device 100 is released from the submersible body 200 and has surfaced from under-water UW to above-water OW, the target part can be moved from the surfaced position. Therefore, the surfacing device 100 can communicate with the outside world at a different position from a position at which the surfacing device 100 has surfaced, by using the moved target part.

In the surfacing device 100, the movement units 13 move the target part by causing it to fly, and the communication unit 10 transmits the target information to the external communication device 300 after the target part starts flying by the movement units 13. Accordingly, the target part flies higher than water surface WS, thereby increasing the sight distance from the target part. Thus, communication with the external communication device 300 can be made easier.

In the surfacing device 100, the communication unit 10 transmits target information to the external communication device 300 while the target part is flying at an altitude of 15 m or higher by the movement units 13. Accordingly, the action and effect produced by the surfacing device 100 described above can be more concretely realized.

In the surfacing device 100, the movement units 13 can cause the target part to fly by generating an upward propulsive force that propels the target part upward. In other words, the target part is propelled upward by the upward propulsive force while its position does not have to be controlled laterally. Accordingly, the movement units 13 can use more of the energy available for moving the target part for upward propulsion (among the energy available for moving the target part). Thus, the target part can be raised to a higher altitude, thereby increasing the sight distance from the target part.

In the surfacing device 100, the movement units 13 can cause the flying target part to descend toward direct-below. Accordingly, the position coordinates at which the target part was flying and the position coordinates at which the target part has descended can be made to coincide with each other. Therefore, by detecting the position coordinates at which the target part has descended, it becomes easier to estimate the position coordinates at which the target part was flying.

In the surfacing device 100, the movement units 13 can cause the flying target part to descend toward a position different from direct-below. This allows the target part to change its position coordinates as it descends, thus enabling a descent over a wider area. This may also be achieved, for example, by suppressing the lateral control of the movement units 13, in which case the energy consumption by the movement units 13 can be suppressed.

In the surfacing device 100, the movement units 13 can cause the flying target part to stay in the same position after the target information is transmitted to the external communication device 300 by the communication unit 10. Accordingly, the target part can stay at a position where the target information can be more reliably transmitted to the external communication device 300. Therefore, if the target information needs to be transmitted again to the external communication device 300, the target information can be transmitted promptly. In addition, since the target part remains in the same position, the surfacing device 100 can be easily discovered by others.

In the surfacing device 100, the movement units 13 will stop the operation after the target information is transmitted to the external communication device 300 by the communication unit 10. Accordingly, energy consumption by the movement units 13 can be suppressed.

The surfacing device 100 is equipped with the separated mobile body 1 which is a part of the surfacing device 100. The separated mobile body 1 has a communication unit 10 and the movement units 13, and after the surfacing device 100 has surfaced from under-water UW to above-water OW, it is separated from the remaining portions of the surfacing device 100 and is moved by the movement units 13. Accordingly, energy consumption by the movement units 13 can be reduced because only the separated mobile body 1 is moved instead of all of the surfacing device 100. In addition, since the separated mobile body 1 is provided with a communication unit 10, it can communicate with the outside world from the separated mobile body 1 that has been moved.

In the surfacing device 100, the movement units 13 can move the separated mobile body 1 by causing it to fly. In this way, the separated mobile body 1 flies higher than water surface WS, thereby increasing the sight distance from the separated mobile body 1. Therefore, communication with the external communication device 300 can be made easier.

The surfacing device 100 is equipped with a container 2 that has an opening/closing portion 22 and can contain the separated mobile body 1 in a sealed state when the opening/closing portion 22 is closed, and can release the sealed state and move the separated mobile body 1 from the inside to the outside when the opening/closing portion 22 is opened. Here, the mobile body 1 is separated from the container 2 and is moved by the movement units 13 after the surfacing device 100 is raised from under-water UW to above-water OW and the opening/closing portion 22 is opened, while the separated mobile body 1 is housed inside the container 2 in the closed state. Accordingly, until the surfacing device 100 has surfaced from under-water UW to above-water OW, the separated mobile body 1 can be contained inside the container 2 in a sealed state to prevent the separated mobile body 1 from coming into contact with water. After the surfacing device 100 has surfaced from under-water UW to above-water OW, the separated mobile body 1 can be separated from the container 2 and such separated mobile body 1 can be moved.

The surfacing device 100 is provided with a detection unit 21 that detects that the surfacing device 100 has surfaced from under-water UW to above-water OW, and the container 2 opens the opening/closing unit 22 when the detection unit 21 detects that the surfacing device 100 has surfaced from under-water UW to above-water OW Accordingly, the action and effect of the surfacing device 100 of suppressing the contact of the separated mobile body 1 with water can be suitably achieved by using the container to enclose the separated mobile body 1 in a sealed state inside the container 2 until the surfacing device 100 has surfaced from under-water UW to above-water OW. Further, the action and effect of the surfacing device 100 of separating the separated mobile body 1 from the container 2 and moving the separated mobile body 1 after the surfacing device 100 has surfaced from under-water UW to water OW can be suitably achieved.

In the surfacing device 100, the container 2 is configured to have an average density of 2.0 g/cm³ or less. Accordingly, since the weight of the container 2 can be reduced, it is possible to suppress the weight of the container 2 from interfering with the levitation of the surfacing device 100.

The surfacing device 100 is provided with a first fixing unit 14 and a second fixing unit 23 capable of fixing the separated mobile body 1 and the container 2 to each other, in a state where the separated mobile body 1 is housed inside the container 2. In detail, the separated mobile body 1 is housed inside the container 2 with the opening/closing unit 22 closed, so that the surfacing device 100 can float from under-water UW to above-water OW, and after the opening/closing portion 22 is made open and the fixation with the container 2 by the first fixing unit 14 and the second fixing unit 23 is released, the mobile body 1 may be separated from the container 2 and may be moved by the movement units 13. Accordingly, it is possible to suppress the tilting or tipping of the separated mobile body 1 inside the container 2 due to, for example, ocean currents or water waves before the mobile body 1 is separated from the container 2.

In the surfacing device 100, the container 2 has a curved surface portion C whose outer surface is configured with a curved surface portion and a non-curved surface portion P whose outer surface is configured with a flat surface. Accordingly, it is easy to improve the pressure resistance of the container 2 in the curved surface portion C, and it is easy to form the opening/closing mechanism of the opening/closing portion 22 in the non-curved surface portion P.

In the surfacing device 100, the separated mobile body 1 floats on water. Accordingly, it is possible to prevent the separated mobile body 1 from being submerged in water when it descends to water surface WS.

In the surfacing device 100, the submersible body 200 is a boardable submersible body on which a crew can board. Accordingly, the action and effect obtainable from the surfacing device 100 described above can be more concretely realized. In particular, the surfacing device 100 can be used to transmit a distress signal to request rescue of the crew.

In the surfacing device 100, the movement units 13 can move the target part in a specific direction. Accordingly, by moving the target part in a direction toward a position where the target information is more likely to be received, communication with the external communication device 300 can be made easier.

Further, the surfacing device 100 is provided with a judgment unit 11 that judges whether or not the external communication device 300 has received the target information transmitted to the external communication device 300 by the communication unit 10, and the movement units 13 do not move the target part when the judgment unit 11 judges that the external communication device 300 has received the target information. Accordingly, when the target information is received by the external communication device 300, the separated mobile body 1 is not moved, thereby reducing energy consumption by the movement units 13.

In the surfacing device 100, the target information includes position information indicating the position of at least one of the submersible body 200 and the surfacing device 100. Accordingly, information regarding the current position of the submersible body 200 can be transmitted to the external communication device 300. In particular, when the rescue signal of the submersible body 200 is transmitted as the target information, it becomes easier for the rescue to be executed quickly.

In the surfacing device 100, the target information includes status information indicating the status of the submersible body 200. Accordingly, information regarding the current status of the submersible body 200 can be transmitted to the external communication device 300. In addition, when a rescue team or the like obtains information on the current status of the submersible body 200 via the external communication device 300, they can be made aware of the information on the current status of the submersible body 200.

In the surfacing device 100, the target information has a data volume of 1 B or more and 50 B or less. In this way, since the data volume of the target information can be reduced, the target information can be transmitted farther.

In the surfacing device 100, the communication unit 10 communicates with the external communication device 300 by radio waves each having a frequency of 1000 MHz or lower. Accordingly, since the wavelength of the radio wave used for communication can be made longer, the target information can be transmitted for a greater distance.

The surfacing device 100 has a movement parameter setting unit 12 that sets movement parameters indicating at least one of distance, altitude, and time over which the target part should move, and the movement units 13 can move the target part according to the movement parameters set by the movement parameter setting unit 12. In this way, by moving the target part to a position where the target information can be more easily received, communication with the external communication device 300 can be made easier.

In the surfacing device 100, the movement units 13 can move the target part until the energy available to the movement units 13 for moving the target part (among the energy available to the surfacing device 100) is exhausted. The communication unit 10 transmits the target information to the external communication device 300 until the energy available to the communication unit 10 for transmitting the target information (among the energy available to the surfacing device 100) is exhausted. Accordingly, since the movement units 13 and the communication unit 10 have more energy available, communication with the external communication device 300 is more likely to succeed. Also, since the movement units 13 and the communication unit 10 can use more energy, the amount of data that can be communicated with the external communication device 300 can be increased.

In the surfacing device 100, the movement units 13 can select a test moving mode in which the target part is test moved to confirm the operation of the movement units 13. In this way, it is possible to confirm in advance whether or not the movement units 13 can operate properly.

In the surfacing device 100, the communication unit 10 can select a test communication mode in which test information is transmitted to the external communication device 300 to confirm the operation of the communication unit 10. Accordingly, it is possible to confirm in advance whether or not the communication unit 10 can operate properly.

The information management device 400 includes: an identification information acquiring unit 30 for acquiring identification information concerning any of the above-mentioned surfacing devices 100; a target information acquiring unit 31 for acquiring target information transmitted to the external communication device 300 by the communication unit 10 provided in the surfacing device 100; and information management unit 33 for managing the identification information acquired by the identification information acquisition unit 30 and the target information acquired by the target information acquisition unit 31 by being linked to each other.

According to this information management device 400, it is possible to manage the target information transmitted to the external communication device 300 for each surfacing device 100 that can communicate with the outside world at a position different from the position at which the surfacing device has surfaced.

In the information management device 400, the target information includes status information indicating the status of the submersible body 200. Accordingly, it is possible to manage information regarding the status of the submersible body 200.

The information management device 400 is provided with a correspondence information generating unit that generates correspondence information concerning correspondence to the submersible body 200 after the target information is obtained by the target information obtaining unit 31. In this way, information on the rescue response after receiving the target information, such as a distress signal, can be managed, enabling, for example, an administrator or the like to grasp the status of the response to the submersible body 200.

The information management unit 400 is provided with a contact information acquisition unit 32 for acquiring contact information of a contact person regarding the submersible body 200, and the information management unit 33 manages the contact information acquired by the contact information acquisition unit 32 by associating the contact information with identification information, and when new target information is acquired by the target information acquisition unit 31, the information contact unit 34 is further provided to contact the contact person based on the contact information associated with the identification information which is in turn associated with the target information. In this way, it is possible to manage the contact information of the contact person regarding the submersible body 200 for each surfacing device 100 that can communicate with the outside at a position different from the surfaced position. When new target information has been obtained, it is possible to contact the contact person of the submersible body 200 related to the surfacing device 100 that has transmitted the target information. Thus, for example, when a distress signal is sent from the surfacing device 100 of one of the submersible bodies 200, it is possible to quickly contact the persons concerned of the submersible bodies 200.

The separated mobile body 1 is a part of a surfacing device 100 that is released from a submersible body 200 submerged in under-water UW and has surfaced to above-water OW by the surfacing unit 20 and communicates with an external communication device 300, while the separated mobile body 1 is a part of a surfacing device 100. The separated mobile body 1 includes: a communication unit 10 capable of transmitting target information to the external communication device 300 after the surfacing device 100 has surfaced from under-water UW to above-water OW; and the movement units 13 that can move the separated mobile body 1 separated from the remaining portions of the surfacing device 100 after the surfacing device 100 has surfaced from under-water UW to above-water OW.

According to this separated mobile body 1, after the surfacing device 100 equipped with the separated mobile body 1 is released from the submersible body 200 and has surfaced from under-water UW to above-water OW, the separated mobile body 1 can be moved from the surfaced position. Therefore, the separated mobile body 1 can communicate with the outside world at a position different from the position from which the surfacing device 100 has surfaced.

### Second Embodiment

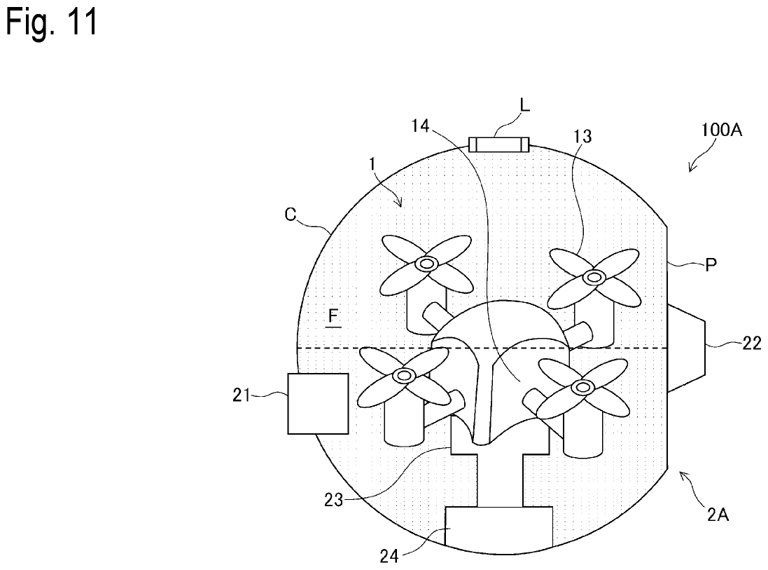

Next, the second embodiment of the surfacing device 100A will be described. FIG. 11 shows the surfacing device 100A according to the second embodiment. As shown in FIG. 11, the surfacing device 100A pertaining to the second embodiment differs from the surfacing device 100 of the first embodiment mainly in that the interior of the container 2A is filled with oil F. Further, an oiling port L is formed at the upper end of the container 2A, and is similar in other respects. The structure of the surfacing device 100A of the second embodiment will be described below in terms of the differences from the structure of the surfacing device 100 of the first embodiment.

The upper end of the container 2A of the surfacing device 100A has a lubricant port L which can be opened and closed. The lubricant port L can be sealed and opened by a cap (for example). The container 2A is filled with oil F when the opening/closing portion 22 is closed. In more detail, the lubricant port L of the container 2A may be opened when the opening/closing portion 22 is closed, and oil F is injected into the interior of the container 2A through the lubricant port L. After the interior of the container 2A is filled with oil F, the lubricant port L is sealed. The oil F functions as so-called equalizing oil. The container 2A may be further equipped with a pressure adjustment mechanism to make the oil F function suitably as a pressure equalizing oil. As the oil F, industrial insulating oil may be suitably used.

As explained above, in the surfacing device 100, the container 2 is filled with oil F when the opening/closing portion 22 is closed. Accordingly, the oil F functions as so-called equalizing oil to suppress water pressure applied to the equipment inside the container 2, such as the separated mobile body 1. In addition, the oil F makes it possible to protect the equipment inside the surfacing device 100 from water in the event that the surfacing device 100 is subjected to water.

### Modified Embodiments

The embodiments described above can be implemented in various forms with modifications or improvements based on the knowledge of those skilled in the art.

For example, some of the individual configurations described in each of the above embodiments may be combined appropriately when being carried out.

In each of the embodiments described above, the submersible body 200 is a submersible. However, the submersible body 200 does not have to be a submersible, but may be a submarine, or a structure or device installed in under-water UW. Furthermore, the submersible body 200 may be a user or other person submerged in under-water UW. In this case, the surfacing device 100 secured (held) to a fixture of the clothing (submersible suit or the like) of the submersible body 200 may be released from the submersible body 200 by unfastening the fixture. Similarly, when the submersible body 200 is a user or the like who has dived into the underwater UW, the surfacing device 100 held in the hands of the submersible body 200 may be released from the submersible body 200 by being released from the hands of the submersible body 200.

In each of the above-mentioned embodiments, the separated mobile body 1 floats in water. Here, the separated mobile body 1 may further have a material member filled with air (e.g., a member made of plastic, polyester or the like) or a member with a lower density (lower weight per unit volume) than water, in order to more exactly float in water.

In each of the embodiments described above, the separated mobile body 1 serving as a target part is apart of the surfacing device 100. However, the target part may also be all parts of the surfacing device 100.

In each of the embodiments described above, the separated mobile body 1 may be a multi-copter (rotary wing aircraft), especially a quadcopter with four propellers. However, the separated mobile body 1 may also be a multi-copter other than a quadcopter, or it may not be a multi-copter. For example, the separated mobile body 1 may be a fixed-wing aircraft or a balloon-type movement unit that is flown by balloons. Specifically, the separated mobile body 1 does not have to be a drone, but may be a device that consists of, for example, communication device, batteries, gas injectors, balloons or the like, or a device that automatically takes flight by injecting gas into the balloons.

In each of the above-mentioned embodiments, the surfacing device 100 has one separated mobile body 1. However, the surfacing device 100 may be equipped with two or more separated mobile bodies 1. The surfacing device 100 may be equipped with a separated mobile body 1 that can dive into under-water UW, or may be a separated mobile body 1 that can fly in the air, or a mobile body that is connected to these two types of mobile bodies 1 (connected mobile bodies). In this case, after the connected mobile bodies have moved into under-water UW, it may be detached from each separate mobile body 1 and the separated mobile body 1 that can fly in the air may start flying.

In each of the above-mentioned embodiments, at least one of the communication units 10, judgment unit 11, movement parameter setting unit 12, movement units 13, control unit 15, and energy storage unit 16 may be provided not only in the separated mobile body 1 but also in the container 2.

In each of the above-mentioned embodiments, the communication unit 10 may be provided in the container 2 as the main unit that executes communication control, while the antenna for transmitting and receiving radio waves may be provided in the separated mobile body 1.

In each of the embodiments described above, each function of the separated mobile body 1 is controlled by the control unit 15. However, each function of the separated mobile body 1 may be realized without being controlled by the control unit 15. For example, the separated mobile body 1 may be configured to be automatically separated from the container 2 and to start moving when a predetermined time (e.g., a time required to float to above-water) has elapsed after the surfacing device 100 is activated (e.g., after the power is turned on).

In each of the embodiments described above, the separated mobile body 1 starts moving after the surfacing device 100 has surfaced from under-water UW to above-water OW. However, the separated mobile body 1 may start moving before the surfacing device 100 completes its surfacing from under-water UW to above-water OW, as long as the separated mobile body 1 starts its movement at least after the surfacing device 100 has surfaced.

In each of the above-mentioned embodiments, the separated mobile body 1 starts moving by the movement units 13 after communication is initiated by the communication unit 10. However, the separated mobile body 1 may also start communication by the communication unit 10 after it starts moving by the movement units 13, or it may start moving by the movement units 13 at the same time it starts communication by the communication unit 10.

1. A surfacing device which is released from a submersible body submerged in under-water and floats to above-water and communicates with an external communication device, comprising:
a surfacing unit that causes the surfacing device released from the submersible body to float from under-water to above-water;
a communication unit capable of transmitting target information to the external communication device after the surfacing device has surfaced from under-water to above-water; and
movement units for moving a target part which is at least a part of the surfacing device, after the surfacing device has surfaced from under-water to above-water;
wherein
the movement units move the target part by causing the target part to fly;
the communication unit transmits the target information to the external communication device after the target part has started flying by the movement units;
the target information includes distress signal.

2. (canceled)

3. The surfacing device according to claim 1, wherein the communication unit transmits the target information to the external communication device while the target part is flying at an altitude of 15 meters or higher by the movement units.

4. The surfacing device according to claim 1, wherein the movement units cause the target part to fly by generating an upward propulsive force that propels the target part upward.

5. The surfacing device according to claim 1, wherein the movement units cause the target part in flight to descend in a straight downward direction.

6. The surfacing device according to claim 1, wherein the movement units cause the target part in flight to descend toward a position different from direct-below.

7. The surfacing device according to claim 1, wherein the movement units cause the target part in flight to remain in the same position after the target information is transmitted to the external communication device by the communication unit.

8. The surfacing device according to claim 1, wherein the movement units stop operation after the target information is transmitted to the external communication device by the communication unit.

9. The surfacing device according to claim 1, including a separable mobile body that is part of the surfacing device,
the separable mobile body includes:
the communication unit and;
the movement units,
wherein after the surfacing device has surfaced from under-water to above-water, the surfacing device is separated from the remaining portions of the surfacing device and is moved by the movement units.

10. The surfacing device according to claim 9, wherein the movement units move the separated mobile body by causing the mobile body to fly.

11. The surfacing device according to claim 9, wherein the surfacing device includes a container, the container has an opening/closing portion, the opening/closing portion being closed to allow the separated mobile body to be housed in a sealed state, and the opening/closing portion being opened to release the sealed state and to allow the separated mobile body to be moved out of interior to exterior;
wherein the separated mobile body is configured to be separated from the container and to be moved by virtue of movement units, after the surfacing device floats from the under-water to above-water with the opening/closing portion in open state, while in a state in which the opening/closing portion is accommodated in the interior of the container in its closed state.

12. The surfacing device according to claim 11, further including a detection unit to detect that the surfacing device has surfaced from under-water to above-water,
wherein the container is configured such that its opening/closing portion is set to be open when the surfacing device is detected by the detection unit to have surfaced from under-water to above-water.

13. The surfacing device according to claim 11, wherein the container is filled with oil when the opening/closing portion is in its closed state.

14. The surfacing device according to claim 11, wherein the container is configured to have an average density of 2.0 g/cm³ or less.

15. The surfacing device according to claim 11, including a fixing unit capable of fixing the separable mobile body and the container to each other, when the separable mobile body is housed in the interior of the container;
wherein the separable mobile body is configured to be separated from the container and to be moved by virtue of the movement units, after the surfacing device floats from under-water to above-water with the opening/closing portion in its open state, and after the fixation with the container by the fixing unit is released, all in a state in which the opening/closing portion is housed in the interior of the container in its closed state.

16. The surfacing device according to claim 11, wherein the container includes:
a curved surface portion whose outer surface is composed of a curved surface; and
a non-curved surface portion whose outer surface is composed of a flat surface.

17. The surfacing device according to claim 9, wherein the separable mobile body floats on water.

18. The surfacing device according to claim 1, wherein the submersible body is a passenger submersible body on which a crew member can board.

19. The surfacing device according to claim 1, wherein the movement units move the target part in a specific direction.

20. The surfacing device according to claim 1, further including a determination unit for determining whether the external communication device has received the target information transmitted to the external communication device by the communication unit;
wherein the movement units do not move the target part when it has been determined by the determination unit that the external communication device has received the target information.

21. The surfacing device according to claim 1, wherein the target information includes location information indicating the position of at least one of the submersible body and the surfacing device.

22. The surfacing device according to claim 1, wherein the target information includes status information indicating the status of the submersible body.

23. The surfacing device according to claim 1, wherein the target information has a data volume of 1 B or more and 50 B or less.

24. The surfacing device according to claim 1, wherein the communication unit communicates with the external communication device by radio waves each having a frequency of 1000 MHz or lower.

25. The surfacing device according to claim 1, further including a movement parameter setting unit for setting movement parameters indicating at least one of distance, altitude, and time over which the target part should move,
wherein the movement units move the target part in response to the movement parameters set by the movement parameter setting unit.

26. The surfacing device according to claim 1, wherein:
the movement units move the target part until the energy (among the energy available to the surfacing device) available to the movement units for moving the target part is exhausted;
the communication unit transmits the target information to the external communication device until the energy (among the energy available to the surfacing device) available to the communication unit for transmitting the target information to the external communication device is exhausted.

27. The surfacing device according to claim 1, wherein the movement units are capable of selecting a test movement mode in which the target part is test moved to confirm the operation of the movement units.

28. The surfacing device according to claim 1, wherein the communication unit selects a test communication mode in which test information is transmitted to the external communication device to confirm the operation of the communication unit.

29. An information management device, comprising:
an identification information acquiring unit for acquiring identification information concerning the surfacing device according to claim 1;
a target information acquiring unit for acquiring the target information transmitted to the external communication device by the communication unit provided in the surfacing device; and
an information management unit that manages the identification information acquired by the identification information acquiring unit and the target information acquired by the target information acquiring unit by linking the information to each other.

30. The information management device according to claim 29, wherein the target information includes status information indicating the status of the submersible body.

31. The information management device according to claim 29, including a correspondence information generating unit that generates correspondence information concerning correspondence to the submersible body after the target information is obtained by the target information obtaining unit.

32. The information management device according to claim 29, including:
a contact information acquiring unit for acquiring contact information of a contact person regarding the submersible body;
wherein
the information management unit manages the contact information acquired by the contact information acquiring unit, by associating the contact information with the identification information;
the device further including an information contacting unit that, when new target information is acquired by the target information acquisition unit, contacts the contact person based on the contact information associated with the identification information that is in turn associated with the target information.

33. A separable mobile body that is part of a surfacing device which is released from a submersible body submerged in under-water and is caused to float to above-water by a surfacing unit and communicates with an external communication device, the separable mobile body comprising:
a communication unit capable of transmitting target information to an external communication device after the surfacing device has surfaced from under-water to above-water; and
movement units for moving the separable mobile body separated from the remaining portions of the surfacing device after the surfacing device has surfaced from the under-water to above-water.
